(19) United States
(12) Patent Application Publication
(10) Pub. No.: US 2004/0212120 A1
(43) Pub. Date: Oct. 28, 2004

(54) Dual wall insulated overmold cup assembly and a method of manufacturing an insulated overmold cup assembly

(76) Inventor: Jean-Pierre Giraud, Paris (FR)

Correspondence Address: GREENBERG TRAURIG, LLP, 885 3RD AVENUE, NEW YORK, NY, 10022, US

(21) Appl. No.: 10/849,454

(22) Filed: May 19, 2004

Related U.S. Application Data
(62) Division of application No. 09/908,861, filed on Jul. 18, 2001.
Application No. 09/908,861 is a division of application No. 09/865,792, filed on May 25, 2001.

(51) Int. Cl. B29C 45/14; B29C 45/40; B29C 45/63

(52) U.S. Cl. 264/102; 264/250; 264/262; 264/334

(57) ABSTRACT

A cup assembly having an open end, comprising: (a) a dual wall cup assembly comprising: (i) an outer cup having a truncated conical-like shape with side wall, larger top and smaller end, the end is closed and sealed by bottom wall and the top is open; (ii) an inner cup having a truncated conical-like shape with side wall, larger top and smaller end, the end is closed and sealed by bottom wall; and (iii) the inner cup is configured to be receivable within the outer cup to create a gap between side wall of an inner surface of the outer cup and an outer surface of the inner cup and between the bottom walls; (b) the cup assembly is a child spill-proof cup that has an upper end for removably mounting cap thereon, the cap is adapted to engage the upper end of the cup, the cap has a spout that projects from one side thereof upwardly, the spout is formed integrally with the cap and includes a front and rear walls that converge to an outwardly protruding tip of the spout; and (c) an overmold ring located on an outer portion of the cup assembly in the area where the top end of the outer cup mates with the inner cup.

### RELATED APPLICATIONS

The present application is a divisional of U.S. Ser. No. 09/865,792, entitled A Dual Wall Insulated Cup Assembly And Method Of Manufacturing An Insulated Cup Assembly, filed May 25, 2001 and claims priority to U.S. Ser. No. 60/218,964, entitled Method of Manufacturing Insulated, Spill Proof Child Cups Using a Mono Sandwich Molding Principle, filed Jul. 17, 2000; U.S. Ser. No. 60/236,298 entitled Multi-Piece Insulated Container, filed Sep. 28, 2000; and U.S. Ser. No. 60/256,274 entitled A Dual Wall Insulated Cup Assembly and a Method of Manufacturing an Insulated Cup Assembly, filed Dec. 18, 2000.

### BACKGROUND OF THE INVENTION

There are numerous containers presently being used to hold hot or cold foods. For example, such containers include cups that are being used to feed liquids to children. One example of such cups are cups that contain covers to minimize spilling by children and are typically known as “spill-proof cups.” These “spill-proof cups” are typically used by children under the age of five. Typically, these cups are injection molded of high density polyethylene (“HDPE”) and are composed of a cup body and a removable screw-top or comparable lid. Moreover, these cups are typically sold in two cup sizes: (1) a 6-ounce cup and (2) a 9-ounce cup. The 6-ounce cup is typically approximately 4″ tall with a lid diameter of 2¼″. The 9-ounce cup is typically approximately 6″ tall with the same lid diameter as the 6-ounce cup. The lid typically has a spout on top where the child can access the liquid contents. In one embodiment, a valve may be provided on the under side of the lid to minimize liquid from leaking out of the spout. In use, the child typically places his/her lips around the spout, tilts the cup up and sucks out the liquid volume. Typically, the wall thickness of these cups is of uniform construction and ranges in thickness from about 0.09 inches to about 0.1 inches depending on cup size.

Another example of a container used to hold hot or cold foods (e.g. beer, coffee, tea and/or soda) is a mug. For example, recent years has seen a considerable upsurge in the popularity of so-called “travel mugs”. A typical travel mug includes a container for a beverage and is fitted with a removable cover. Conventionally, the cover will be provided with a mouth piece or an opening of limited size through which the beverage may be withdrawn by the user of the mug. This configuration allows considerable sloshing of the beverage within the mug without spilling because the limited size of the opening through the cover or the mouth piece is such as to substantially confine all of the liquid. Frequently, in one specific embodiment, the opening may be at the bottom of a recess in the cover. Thus, to the extent that a beverage may pass through the opening to the exterior of the mug and remain in the recess, it will drain back into the mug, again preventing the spilling of the beverage. In addition, the “travel mug” may be advertised as having insulation abilities.

Moreover, containers are also presently being used for drinking glasses for containing cold or hot drinks. Other containers are presently being used to handle hot liquids such as hot beverages, soup, and the like. These type of containers are presently being used in large quantities in the fast food and other industries requiring disposable containers.

### DESCRIPTION OF THE DRAWINGS

FIG. 1 is a vertical sectional cut-away view of one embodiment of the present invention.

FIG. 2A is an enlarged, fragmentary vertical section view of one embodiment of the present invention.

FIG. 2B is an enlarged, fragmentary vertical section view of the inner and outer cups' interface of one embodiment of the present invention.

FIG. 3 is a schematic of a process of forming the cup assembly according to one embodiment of the present invention.

FIGS. 4A, 4B and 4C are vertical sectional cut-away views of another embodiment of the present invention where 4A is a cut-away of the outer cup, 4B is a cut-away of the inner cup and 4C is a cut-away of the cup assembly having the inner cup inserted in the outer cup.

FIGS. 5A and 5B is another embodiment of the present invention exemplifying the over-mold ring where FIG. 5B is an enlarged, fragmentary vertical sectional view of the cup assembly taken approximately along the line 2-2 in FIG. 5A.

FIG. 5C is an enlarged, fragmentary vertical sectional view of the cup assembly taken approximately along the line 3-3 in FIG. 5A of an embodiment of the present invention.

FIG. 6 is a vertical sectional cut-away view of the inner and outer cups in the mold of step 3 of one embodiment of the present invention.

FIG. 7 is an illustration of one embodiment of venting grooves shown on a top cut-away view of the inner cup.

FIG. 8A is a vertical sectional cut-away view of one embodiment of the present invention showing the grooving vents and FIG. 8B is an enlarged, fragmentary vertical section view showing the grooving vents.

FIGS. 9A and 9B are vertical sectional cut-away views of another embodiment of the present invention showing a curved region at a bottom outside edge of the outer cup having a thickness greater than the wall thickness of the outer cup and a notch in a curve region at a bottom inside edge of the outer cup where FIG. 9A is a cut-away of the cup assembly having the inner cup inserted in the outer cup and FIG. 9B is an enlarged cut-away view of a portion of the dual wall cup assembly showing the same.

### DETAILED DESCRIPTION OF THE INVENTION

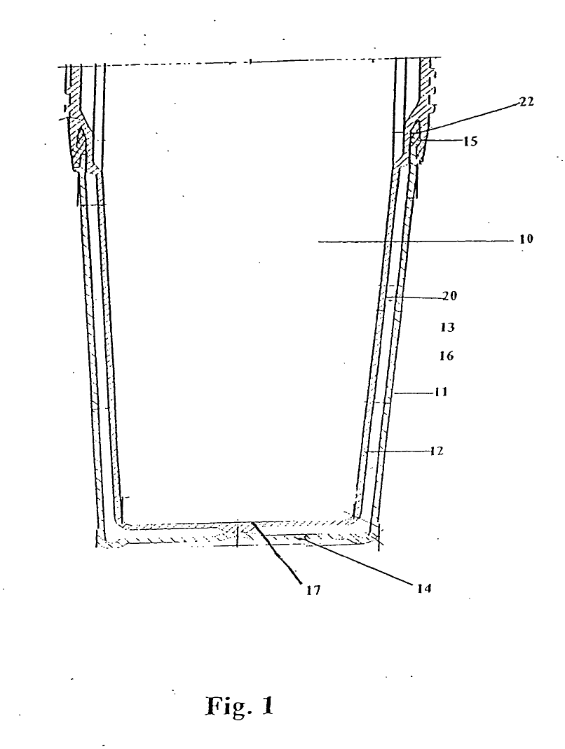

For purposes of the description of the present invention, the terms “upper”, “lower”, “right”, “left”, “rear”, “front”, “vertical”, “horizontal”, and derivatives thereof shall be related to the invention as oriented in FIG. 1 as if the container was sitting on a table. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present invention relates to a dual wall insulated cup assembly and method thereof for hot and cold foods having insulating ability by having at least a “dual” structure wherein an inner cup, in one embodiment, is given a different taper than an outer cup to form a insulating air layer or gap between the inner and outer cup. The present invention results in numerous advantages for the insulated container that (a) is thermally insulating for comfortable handling and for maintaining the temperature of its contents, (b) is sturdy enough to withstand prolonged handling, (c) can be made of biodegradable and recyclable materials, (d) is inexpensive to manufacture, and (e) has good insulating properties. The present invention may be used in the applications, which were discussed above in the background of the invention, including cups that are being used to feed liquids to children; mugs to hold hot or cold beverages; and containers that are used to handle hot liquids such as hot beverages, soup, and the like (e.g. “fast food” providers).

In one embodiment, a cup assembly having an open end, comprising: (a) a dual wall cup assembly comprising: (i) an outer cup having a truncated conical-like shape with side wall, larger top and smaller end, the end is closed and sealed by bottom wall and the top is open; (ii) an inner cup having a truncated conical-like shape with side wall, larger top and smaller end, the end is closed and sealed by bottom wall; and (iii) the inner cup is configured to be receivable within the outer cup to create a gap between side wall of an inner surface of the outer cup and an outer surface of the inner cup and between the bottom walls; and (b) the cup assembly is a child spill-proof cup that has an externally threaded upper end for removably mounting cap thereon, the cap has a depending collar, the collar has an internal thread adapted to threadedly engage the threaded upper end of the cup, the collar includes an inner flange that extends around the cap concentrically with and inside of the thread, the cap has a spout that projects from one side thereof upwardly, the spout is formed integrally with the cap and includes a front and rear walls that converge to an outwardly protruding tip of the spout, and a valve located adjacent to or incorporated into the spout wherein the valve substantially prevents a liquid from leaking out of the spout.

FIG. 1 shows a cross-section of a one embodiment of the present invention. Specifically, there is a cup assembly 10 comprised of an outer cup 11 and an inner cup 12. Cup 111 is a regular cup and has a truncated conical-like shape with side wall 13. The smaller end of cup 11 is closed and sealed by bottom wall 14. The larger end of cup 111 is open at 15. Cup 12 is a regular cup and has a truncated conical-like shape with side wall 16. The smaller end of cup 12 is closed and sealed by bottom wall 17. The larger end of cup 12 curves with a cylindrical section having a bottom wall portion 22 and at the top is open. In one example, the cone angle of outer cup 11 is equal to or less than that of inner cup 12. Cups 11 and 12 are inserted within each other. As a result, an air space or gap 20 is created between side walls 13 and 16 and between bottom wall 17 and 14 and thus, surrounds the gap between the inner and outer cup. The contacts between the two cups at locations 15, 22 may provide additional support for inner cup 12 and maintain it in axial alignment with outer cup 11. In another embodiment, side wall 16 may be extended beyond bottom wall 17 and contact bottom wall 14 to provide an air space 20 between bottom walls 14 and 17.

Gap 20 between cups 11 and 12 are essentially closed and thus, reduce heat transfer between the contents of cup assembly 10 and the surrounding environment (hereinafter “air gap”). In a further embodiment, gap 20 may consist of a negative pressure (i.e. any pressure less than atmospheric pressure up to a perfect vacuum). For example, the negative pressure may be in the range of about 400 mbars to about 800 mbars, more specifically, from about 500 mbars to about 700 mbars. The maximum degree of negative pressure will be dependent on the plastic material and the thickness of the wall. Instead of air, the “air” gap may be filled with other desired gases (e.g. nitrogen) and/or insulating liquids. In another embodiment, the gap may be occupied by an insulating material such as a foam, blowing agent, styrofoam, and/or cardboard.

In addition, the walls of the inner and outer cup may be sufficiently thick to allow for at least a partial vacuum in the air gap (in the range of about 300 to 900 mbars). In another example, the gap may be filled with at least one type of low thermoconductive gas selected from the group of xenon, krypton, and argon. In one example, the container may be used to keep foods warm or cold for a longer time. Also due to reduced heat transfer, outer cup 11 does not get as hot from the contents of inner cup 12 and the hand should be able to hold cup assembly 10 comfortably without feeling excessive heat or burning.

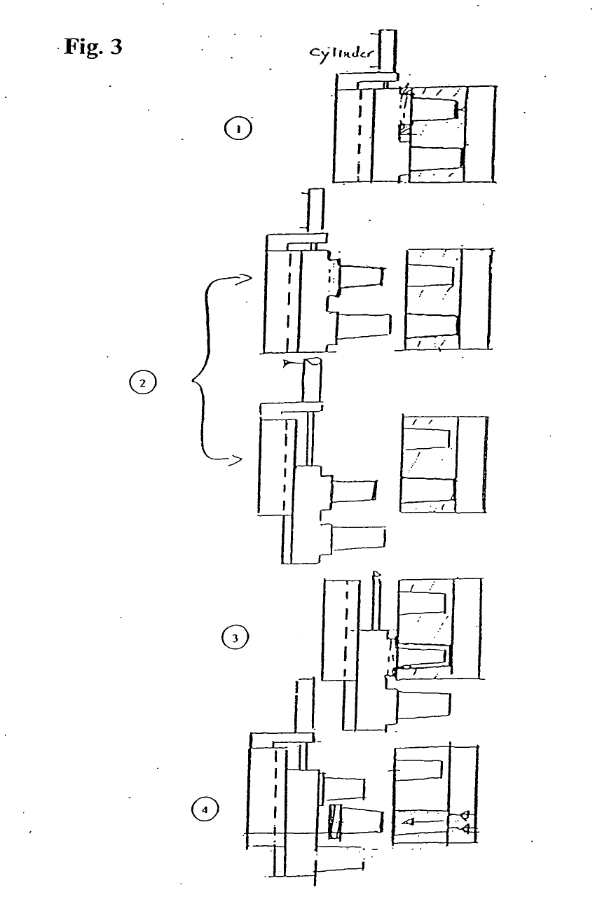

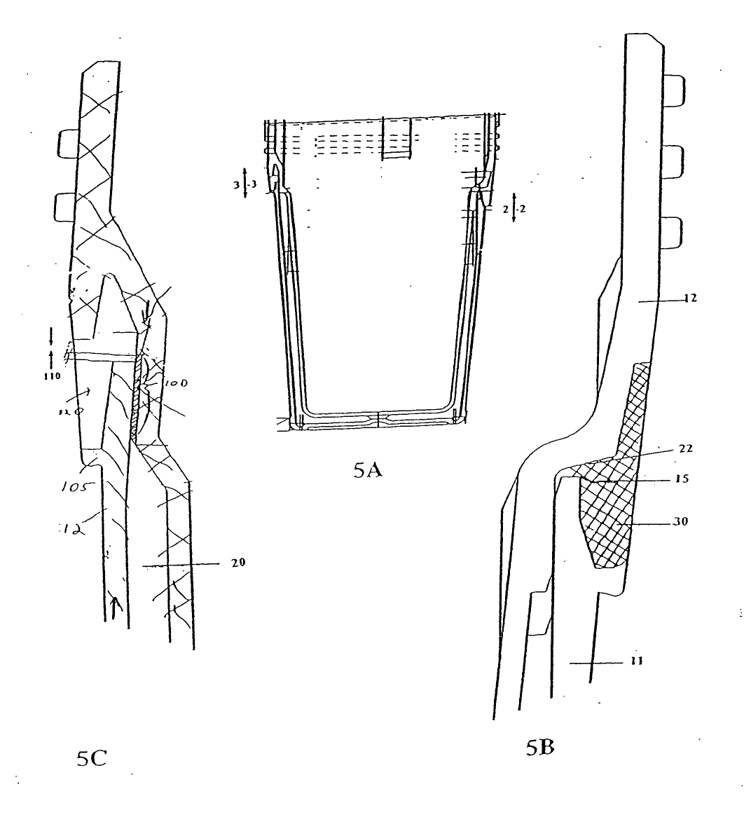

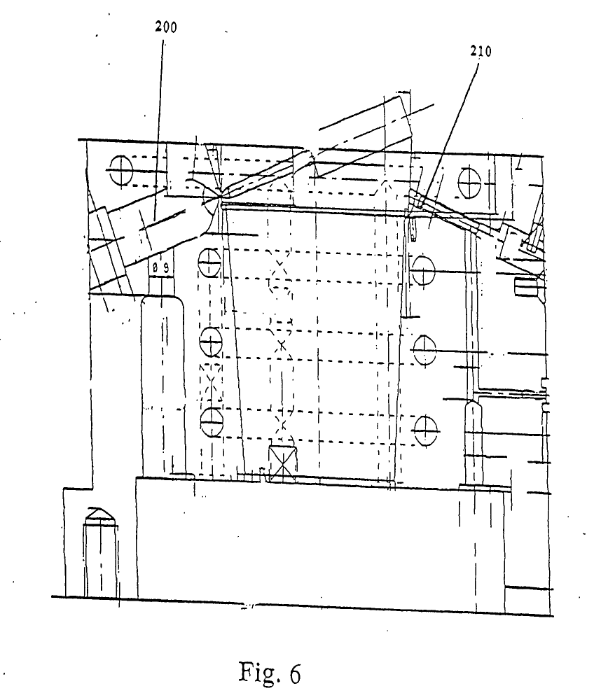

In a further embodiment, as shown if FIG. 5B, ring 30 such as a layer and/or bead of plastic may be also applied to the outer portion of the cup in the area of locations 15, 22 to further seal the space between the abutment of the inner and outer cups at location 15 and 22. This ring may further assist in preventing leakage of liquid into the air gap and thus, prevent a loss of insulation properties and a source for microbiological contamination. In one embodiment, ring 30 is applied as an “overmold ring.” The term “overmold” is used as the conventional term is used for injection molding processes where a second layer of plastic is subsequently injected over a first layer of plastic. As one example of applying the overmold ring, a method is detailed below and illustrated in one example in FIG. 3. However, it is understood that the method described below is one method and not meant to limit methods of applying the overmold ring. The layer and/or bead may be composed of the same plastic as the other parts of the cup or of another plastic. For example, the layer and/or bead may be composed of a plastic that is softer and/or more resilient (e.g. a plastic with a higher elastomer content) so as to reduce slippage when hand held. In addition, in another example, the layer may be of a sufficient width so as to act as an additional grip when hand held.

The selection of the polymer, the size of the “air” gap and/or the thickness of the inner and/or outer cups may effect the insulating ability of the container. Consequently, it is understood that a polymer with a lower thermal coefficient for a material, will result in a greater heat transmission rates as well. Material thickness will also effect the time sensitivity of a structure to heat loss. Thus, the thicker the material, the greater the time before heat loss begins. As well, an increase in the air gap within limits should increase the insulation ability of the container.

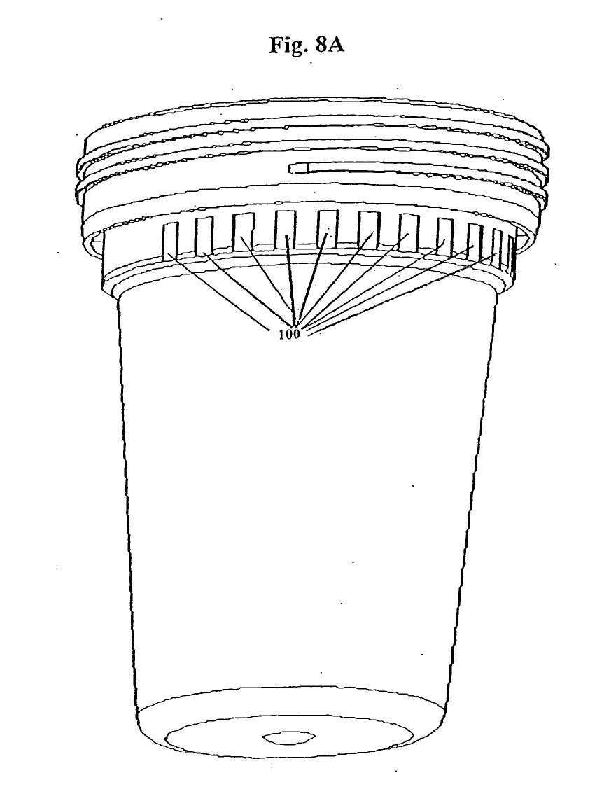

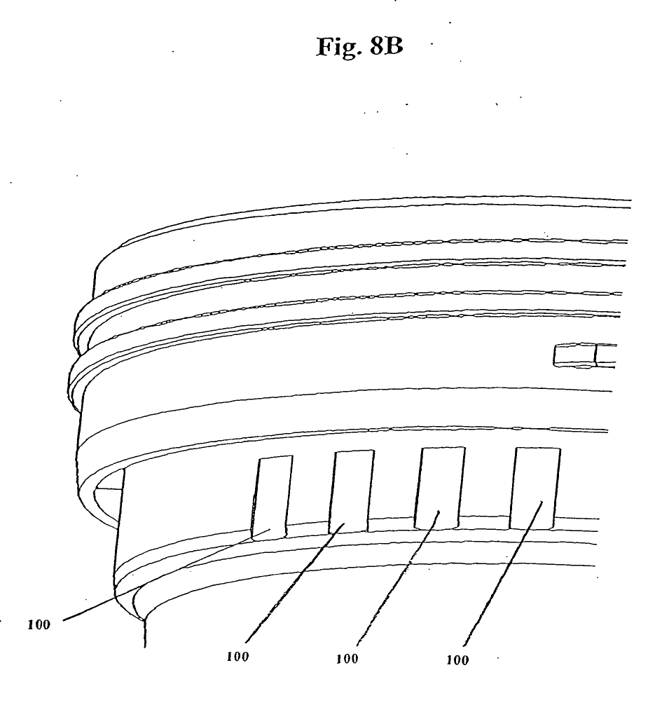

In one embodiment, inner cup 12 has a plurality of “venting grooves” 100. FIG. 7 is an illustration of one embodiment of the venting grooves 100 shown on a top cut-away view of the inner cup. In another embodiment, the venting grooves may be on the inside surface of the outer cup. The venting grooves allow air to escape from the space between the inner and outer cups (e.g air space 20) when the inner and outer cups are brought together. As such, the venting grooves prevent the gap in the area of 15, 22 from prematurely closing up prior to allowing the excess air to escape. In one embodiment, venting grooves 100 are equally spaced around at least a portion of the outside circumference of the inner cup. The number of venting grooves and the size of each individual venting groove are such that the air between the inner and outer cup is sufficiently displaced in the time required to bring the inner and outer cup together. In one example, about 20 to about 30 venting grooves, more specifically about 25 venting grooves, are on the outside surface of the inner cup. In one design of grooves 100, as illustrated in FIGS. 8A and 8B, the indentation on the outer surface of the inner cup has a depth of about 0.2 to about 0.4 mm, more specifically about 0.3 mm, a width of about 2 to about 4 mm, more specifically about 3 mm, and a length of about 3 to about 6 mm, more specifically about 4 to about 5 mm.

FIG. 5C is an embodiment illustrating the location of venting groove 100 on inner cup 11. FIG. 5C is an illustration of the side walls of inner cup 11 and outer cup 12 at the point in time when the cups are first mated together. Gap 110 is the space between outer cup 12 and inner cup 11. The air, which is displaced when inner cup 11 and outer cup 12 are brought together, escapes through venting groove 100 and then through gap 110. Gap 110 is sufficiently large enough to allow the air between the inner and outer cup to be sufficiently displaced in the time required to bring the inner and outer cup together and to escape through venting grooves 100. At the same time, in one embodiment, gap 110 is sufficiently small enough so that the gap closes up during the inherent shrinkage of the inner and outer cups prior to the time that the overmold ring is molded in the area 120 where plastic is injected to form the overmold ring. Gap 110 should sufficiently close up prior to injecting the plastic for the overmold ring to avoid any plastic from flowing into air gap 20 and thus, to avoid detrimentally effecting the insulating properties of the cup. In one embodiment, gap 110 is about 1.5 to about 3 mm wide, about 2 to about 2.5 mm wide or about 2.2 mm wide.

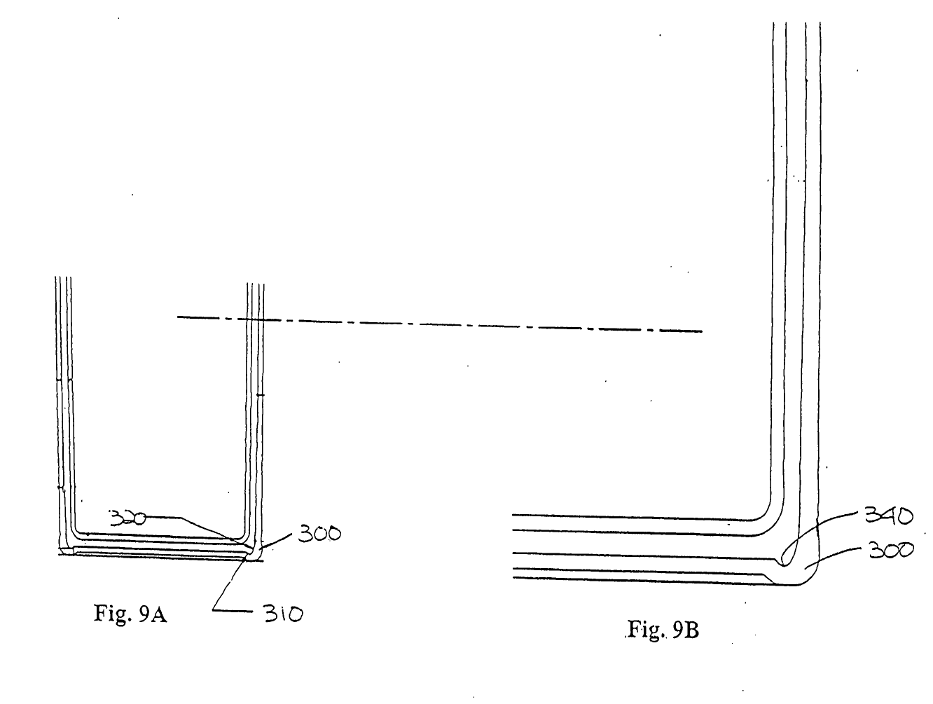

FIGS. 9A and 9B are vertical sectional cut-away views of another embodiment of the present invention showing curved region 300 at a bottom outside edge of the outer cup having a thickness greater than the wall thickness of the outer cup and a notch 340 in a curve region at a bottom inside edge of the outer cup. FIG. 9A is a cut-away of the cup assembly having the inner cup inserted in the outer cup showing minor radius 310 and major radius 320 wherein, in one embodiment, notch 340 has a minor radius 310 of about 0.02 to about 0.06 inches and major radius 320 of about 0.1 to about 0.3 inches. FIG. 9B is an enlarged cut-away view of a portion of the dual wall cup assembly showing notch 340 and curved region 300 at a bottom outside edge of the outer cup having a thickness greater than the wall thickness of the outer cup. In another embodiment, minor radius 310 is about 0.03 inches and major radius 320 is about 0.2 inches.

In the embodiment shown in FIG. 3, inner cup 11 is on the “male” portion of the mold and outer cup 12 is on the “female” portion of the mold. Due to these mold portions and while the inner and outer cup are in the mold, inner cup 11 will inherently shrink in a downward direction (as oriented as in FIG. 1 with the cup sitting on a table) and outer cup 12 will inherently shrink in an upward direction (as oriented as in FIG. 1 with the cup sitting on a table). Consequently, in one embodiment, the present invention utilizes the inherent shrinkage that occurs and sizes gap 110 to close up when inner cup 11 and outer cup 12 inherently shrink while in the mold and prior to the injection of the plastic for the overmolding ring.

FIG. 5C illustrates a further embodiment with bump 105 on outer cup 12. Bump 105 is located sufficiently close to the top edge of outer cup 12 to minimize the shrinkage in the upward direction of outer cup 12 when outer cup 12 is in the mold by restraining the upward shrinkage forces. Therefore, gap 110 essentially closes up when inner cup 11 shrinks in the downward direction. It is understood that the location of bump 105 may be moved in either direction depending on whether the shrinkage of the outer cup is desired to be increased or decreased.

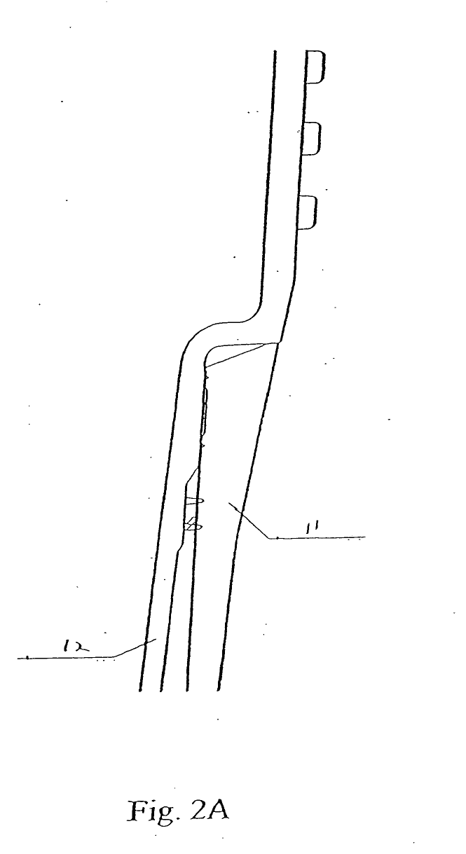

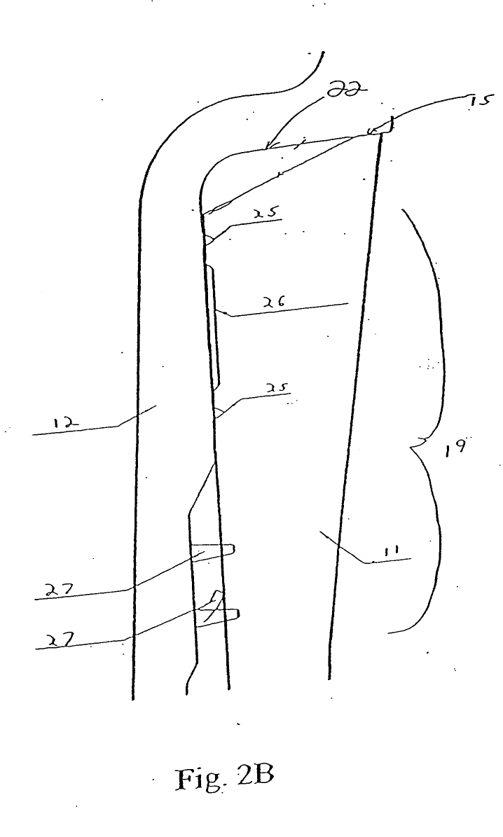

FIGS. 2A and 2B are enlarged portions of another embodiment of FIG. 1. Specifically, FIG. 2A is a portion of the side walls of the inner and outer cup magnified five times. FIG. 2B is a portion of the side walls of the inner and outer cup magnified about twelve times. These figures detail the portion of the side wall having the “molded parts” of the inner cup and are only one embodiment of providing sufficient force to keep outer cup 11 and inner cup 12 together. In this embodiment, the “molded part” of the inner cup comprises one or more of the following elements: (a) one or more diameter ribs 25; (b) a plurality of vertical ribs 26; and (c) one or more lamella 27. It is understood that equivalent structures from the “molded” parts listed above may be used without deviating from the function of these parts.

In one example, the diameter ribs 25 are located on side wall 16 below location 22. One or more ribs extend circumferentially around the diameter of side wall 16. In yet another embodiment, two ribs are located on side wall 16 with one placed above vertical rib 26 and the other placed below vertical rib 26. In one example, the ribs are in the shape of a triangle: (a) with the point of the triangle being in contact with side wall 13 of the outer cup when the two cups are combined; (b) the height of the triangle is in the range of about 0.2 to about 0.4 mm, more specifically, about 0.3 mm; and (c) the width of the triangle is in the range of about 1 to about 3 mm, more specifically about 2 mm. The diameter ribs assist in preventing the inner cup from being pulled out of the outer cup by a compression and/or friction fit with the inner surface of the outer cup.

In another example, a plurality of vertical ribs 26 are connected to an outer surface of side wall 16 and extend along the axial length of the cup 10. Typically, the ribs 26 are uniformly distributed around the outer surface of the side wall 16 and define a series of uniformly-spaced gaps between the ribs 26. In one example, each of the ribs is distanced from an adjacent rib by a predetermined distance known as a gap width (e.g. about 2 to about 3 mm). In a specific example, each vertical rib is in the shape of a triangle: (a) with the point of the triangle being in contact with side wall 13 of the outer cup when the two cups are combined; (b) the height of the triangle is in the range of about 0.2 to about 0.4 mm, more specifically, about 0.3 mm; and (c) the width of the triangle is in the range of about 1 to about 3 mm, more specifically about 2 mm. The length of the vertical ribs may be selected for the desired application and, in one application, are in the range of about 5 to about 15 mm. The vertical ribs assist in reducing the rotational forces that occur when a cover is screwed on and off of the container and thus, in preventing the inner cup from being pulled out of the outer cup. The vertical ribs contact the inner wall of the outer cup by a compression fit with the surface of the inner surface of the outer cup.

In yet another example, one or more lamella 27 are located on side wall 16 below location 22. The lamella extend circumferentially around the diameter of side wall 16. In yet another embodiment, two lamella are located on side wall 16 with both located below vertical rib 26 and diameter rib 25. In one example, the lamella are in the shape of a triangle with the point cut-off: (a) with the point cut-off of the triangle being in contact with side wall 13 of the outer cup when the two cups are combined; (b) the height of the triangle is in the range of about 1 to about 1.5 mm, more specifically, about 1.2 mm; and (c) the width of the triangle is in the range of about 0.2 to about 0.6 mm, more specifically about 0.4 mm. As shown in FIG. 2A, the lamella are designed so that they sufficiently flexible (e.g. deformable) to form an air-tight seal. In one embodiment, a desired amount of elastomer may be added to the plastic to achieve the desired flexibility of the lamella.

In an embodiment shown in FIG. 2B, when the cups 11 and 12 are inserted within each other, the relative dimensions of the two cups are such that the molded parts (25,26,27) on side wall 16 of inner cup 12 pushes against the inside of outer cup 11 at contact area 19 below location 15, location 15 contacts bottom wall portion 22 and the bottom wall 17 does not touch bottom wall 14 of outer cup 11.

In one embodiment, the present invention may be designed for cups that contain covers to minimize spilling by children that are known as “child spill-proof cups.” It is understood that the phrase “spill-proof” means the use of a cup by children with a cover and spout that minimizes spilling when tilted or put upside down but does not mean that the cup prevents leakage when tilted or put upside down. These “spill proof cups” are typically used by children under the age of five. Conventionally, the cups are injection molded of high density polyethylene (“HDPE”) and are composed of a cup body and a removable screw-top or comparable lid. Moreover, there are typically two cup sizes commonly used: (1) a 6-ounce cup and (2) a 9-ounce cup. The 6-ounce cup is approximately 4″ tall with a lid diameter of 2¼″. The 9-ounce cup is approximately 6″ tall with the same lid diameter as the 6-ounce cup. The lid typically has a spout on top where the child can access the liquid contents.

In a specific embodiment of a “spill-proof cup,” the cover can be integrally attached to the cup body by a hinge and a leak-proof seal incorporated into the body and cap. FIG. 5 of U.S. Pat. No. 4,783,056 shows an example of one type of seal and integrally attached cap that can be used in this embodiment, which is incorporated by reference herein.

In one embodiment, a valve on the under side of the lid may substantially prevent liquid from leaking out of the spout. Examples of valves that may be used with the present invention include, but are not limited to, the valves disclosed in U.S. Pat. Nos. 5,079,013, 5,542,670, RE37,016, and U.S. Pat. No. 6,050,445, which are incorporated by reference herein. In use, the child typically places his/her lips around the spout, tilts the cup up and sucks out the liquid volume. Since the “spill proof cup” may contain perishable liquids (e.g. milk), there is a market need to improve the insulating qualities of the cup. The wall thickness is of uniform construction and ranges in thickness from about 1 to about 1.5 mm, more specifically about 1.3 mm depending on cup size.

More specifically, in one embodiment of the child “spill proof cup,” the cup is a standard container having an externally threaded upper end for removably mounting cap thereon. The cap has a substantially flat top with a depending collar. The collar has an internal thread adapted to threadedly engage the threaded upper end of the cup. A collar includes an inner flange that extends around the cap concentrically with and inside of the thread. The inner flange forms a recess for receiving a washer-like sealing ring, which ring is adapted to sealingly engage an upper edge of the cup to form a seal between the cap and the cup. The washer-like sealing ring could be eliminated if desired. In addition, the top of the cap may have a generally circular shape, and a spout projects from one side thereof upwardly. The spout is formed integrally with the cap, and includes generally arcuate front and rear walls that converge to an outwardly protruding tip of the spout. In one example, the tip may include one or more spaced-apart openings, the size and area of which are chosen to provide adequate fluid flow to a young user. In another example, a cylindrically shaped or barrel-shaped tubular flange may extend downwardly from the bottom of the spout. In use, the cover is screwed on to the top of the container by cooperant threads.

In yet another embodiment, the upper end of the cap in conjunction with the cap can have other types of methods for engaging the cap to the upper end of the cap including, but not limited to, snap-on, flip-fop and “push down and turn.”

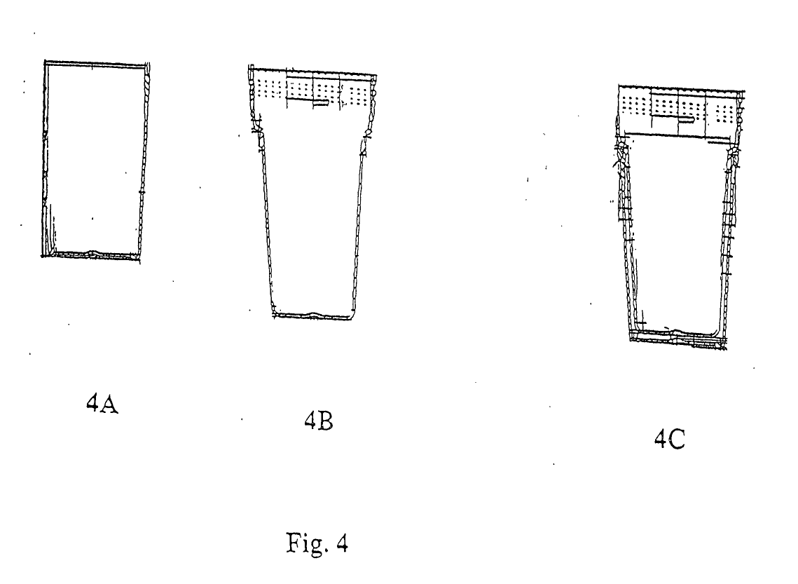

FIGS. 4A-C and 5A-B are one specific embodiment of a child “spill-proof” cup. It is understood that the dimensions shown on these figures are merely exemplary and are not meant to limit the child “spill-proof” cup embodiment to these specific dimensions. These figures show one example of the dimensions used in a child “spill-proof” cup. It is further understood that the dimensions of the “spill-proof” cup assembly may be limited to: (a) a maximum outside diameter of the outer cup by the size of a typical child's hand so the child can sufficiently grasp the cup; (b) a maximum height of the cup so that so that the cup does not easily tip over when containing liquid; and (c) a minimum inside diameter of the inner cup that meets the fluid volume requirement of the cup (e.g. 6 or 9 oz. cup). Once these dimensions are specified, the dimension of the “air” gap between the outside diameter of the inner cup and the inside cup of the outer cup will be limited within a fixed range.

It should be noted that the container of the present invention may be used with any type of foods. The term “food” is used generically to include any solid food, powdered food, liquid food (e.g. soups), and hot and cold beverages. The polymeric cup 10 can be made of various materials which exhibit good strength and a resistance to high temperatures. These materials may also be capable of being subjected to energy produced by a microwave oven. For example, polypropylene or high density polyethylene may be used. If the use of the cup 10 is in an insulated container that contains cold foods like yogurt or ice cream, then the polymeric cup may be also made of high density polyethylene or copolymer polypropylene which provides good resistance to freezing without the risk of fracturing. The insulative container may also contain foods which require heat before serving such as soups, chili, hot beverages, pastas, etc. The insulative container may also be used for cold foods such as ice cream, yogurt, frozen fruits, and cold beverages.

Examples of suitable plastics that may be used to form the container assembly of the present invention include, but are not limited to, thermoplastics such as polyolefins such as polypropylene and polyethylene, polyisoprene, polybutadiene, polybutene, polysiloxane, polycarbonates, polyamides, ethylene-vinyl acetate copolymers, ethylene-methacrylate copolymer, poly(vinyl chloride), polystyrene, polyesters, polyanhydrides, polyacrylianitrile, polysulfones, polyacrylic ester, acrylic, polyurethane and polyacetal, or copolymers or mixtures thereof. In another embodiment, a synthetic resin material having an excellent gas-barrier capacity (hereinafter, referred to as “gas-barrier resin”), and specifically a resin having a gas permeability rate (ASTM Z 1434-58) as a film material of not more than 0.1 g/m²/24 hr/atm for O₂, N₂, and CO₂, may be employed the container. Examples of such resins include polyesters like polyethylene terephthalate, polybutylene terephthalate, and polyethylene naphthalate, as well as various resins such as polyamide, ethylene vinyl alcohol, polyvinylidene chloride, polyacrylonitrile, polyvinyl alcohol and the like. Moreover, a synthetic resin which is heat resistant, moisture resistant (rate of resistance to water-vapor transmission) and is equipped with mechanical strength (hereinafter, referred to as “moisture resistant resin”), and specifically a synthetic resin which is heat resistant with a thermal deformation temperature (ASTM D 648) not less than 100° C. and a water-vapor transmission rate (JIS Z 0208) not more than 50 g/m²/24 hr or less, may be employed for the container assembly. Examples of this type of resin include polypropylene, heat and moisture resistant polycarbonate, and the like.

It is also understood that the specific type of plastic that may be selected may also be based, at least in part, on a polymer with a lower thermal coefficient for a material. In addition, the actual thickness of the walls of the inner and outer cup may also be based, at least in part, on the time sensitivity of a structure to heat loss. Thus, the thicker the material, the greater the time before heat loss begins.

The insulated container of the present invention may be produced in a numerous ways. One way that the insulated container of the present invention may be produced is illustrated in FIG. 3. In one embodiment, the inner and outer cups are formed in the same mold assembly and assembled either before the material is fully set or after the material is fully set. In step (1), which will be referred to as the “inner/outer cup plastic injection step,” the inner cup (upper mold in FIG. 3) and the outer cup (lower mold in FIG. 3) are formed in the mold in the same step. Conventional injection plastic molding techniques may be used for the inner/outer plastic injection step. In step (2), the mold is opened and the mold piece corresponding with the inner cup is aligned with the mold piece corresponding with the outer cup. In one method of aligning the molds in step (2) after the molds are opened, a hydraulic or pneumatic cylinder may be used to move either the mold containing the inner cup or the mold containing the outer cup in alignment with the opposite mold piece. In step (3), the mold is sufficiently closed so that the cups mate (i.e inner cup is inserted into the outer cup or outer cup is brought over inner cup) but “air” gap 20 is maintained between the cups. And, in an optional procedure, step (3) may also include a process where “overmold ring” 30 is applied to the cup assembly, either before the inner and outer cups are fully set or after the cups are fully set, where a bead and/or layer of plastic is injected into the mold at or near the interface where the inner and outer cups meet (e.g. in the area of locations 15, 22) to further seal the space between the abutment of the inner and outer cups at location 15 and 22. An example of overmold ring 30 is shown in FIG. 5B. As such, after the ring is fully set, the ring forms a shrinkage fit with the cup. Subsequently, in step (4), the mold is opened and the multi-piece insulated cup of the present invention is ejected from the mold. Examples of suitable ejection means include, but are not limited to, pop off devices and equivalent devices. The total cycle time may range between about 20 and about 40 seconds, in another embodiment, between about 25 and about 35 seconds. By employing this method, the shrinkage of the inner and outer cups, as the plastic cools, may result in a more efficient shrinkage fit of the inner and outer cups. It is understood that, rather than the “translation” motion (i.e. downward or upward motion) of the mold in step (2), the mold or molds may be moved in a “rotational” motion (i.e. circular motion).

In one embodiment of the method described above and detailed in FIG. 3, the inner cup is inserted into the outer cup before the material is fully set. And, in another embodiment, the overmold ring is applied to the cup assembly before the inner and outer cup material is fully set. In one example, the overmold ring is applied while the inner and outer cup are in the mold. In another example, the ring is applied after the cup assembly is ejected from the mold but before the material is fully set.

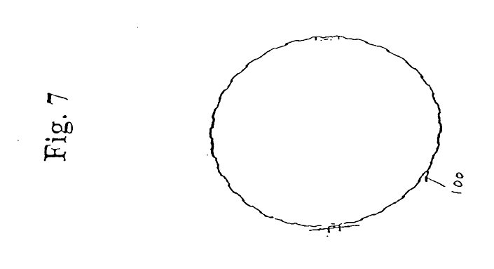

In another embodiment, a negative pressure (e.g. sucking) may be applied to the gap between the inner and outer cup while the cup assembly is in the mold (e.g. during steps 2 and 3) and prior to applying the ring to the cup assembly. FIG. 6 illustrates one embodiment of the placement of negative pressure tube 210. FIG. 6 shows that negative pressure tube 210 is mounted at the top part of the cavity of the outer cup. In the method shown in FIG. 3 and discussed above, negative pressure tube 210 is of a sufficient size to pull the air, which is between the inner and outer cup, that is to be sufficiently displaced in the time required to bring the inner and outer cup together and to escape through venting grooves 100. At the same time, vacuum tube 210 and corresponding negative pressure must be sufficiently small so that the plastic located at the nozzle of negative pressure tube 210 is not accidentally sucked through vacuum tube 210. Consequently, as a guide, the level of negative pressure should be below the melt flow index of the plastic used. As well, in one embodiment, after applying a negative pressure to the gap between the inner and outer cups by way of a groove, the groove is filled with plastic. FIG. 6 also shows an example of the placement of overmold ring injection nozzle 200.

The following is a specific example of the process conditions for the method shown in FIG. 3 for a cup made of HDPE. It is understood that these are merely exemplary conditions and thus, are not meant to limit the present invention. Stage (1) comprises the following: the mold is closed; the plastic is injected into the inner and outer cup molds; and the plastic is cooled prior to opening the molds. The injection cylinder operates at about 210 to 230 C. The injection pressure is about 70 to 80 bar, more specifically 73 bars. The injection speed is about 30 mm/sec. The injection time is about 4 seconds. Stage (2) comprises opening the mold, moving the mold so that the inner and outer cup are aligned and closing the mold. As noted above, a vacuum valve is opened and a negative pressure is drawn through the negative pressure tube during the closing operation. Stages (3) and (4) comprises the following: the plastic is injected for the overmold ring; the mold is opened; the cup assembly is ejected; and the molds are re-aligned to prepare for step (I) again. The injection pressure for the overmolding is about 35 to 40 bar, more specifically 38 bar. The injection speed is about 25 mm/sec. The injection time is about 5 seconds. The cooling time, prior to opening the mold, is about 6 seconds. Thus, the total cycle time for stages (1) through (4) is about 25 to about 35 seconds, more specifically about 31 seconds. It is understood that, as similarly performed by conventional injection molding processes at the end of a cycle, the molds may be cooled by a water valve and the injection valves may be blown to clean them prior to the next cycle.

In yet another embodiment, the ring applied to the cup assembly may be composed of a material that is different than the material of the cup assembly. For example, the ring may be composed of a plastic with a higher amount of elastomer than the material of the cup assembly. In a further embodiment, the ring may be injected “inside” the cup assembly—in the gap between the inner and outer cups.

It is understood that the phrase “before the material is fully set” means that the plastic material are at a temperature between the glass transition temperature (“Tg”) and the melting point (“Tm”) of the material such that: (a) the cap assembly is rigid enough to retain their shape and be moved without damage; and (b) the sealing surfaces between the cup assembly and ring are warm enough to conform to each other to make the required leak-proof seal. Tg is the temperature below which the thermoplastic behaves like glass (i.e., the material is fully rigid and brittle). At or above Tg, the plastic is not as strong or rigid as glass, and is not brittle. And finally, above Tm, the plastic is a fluid melt. As a thermoplastic cools from Tm to Tg, it will shrink and increase in rigidity—a process known as “setting”. When a plastic material is at a temperature between Tg and Tm, it is in a pliable/conformable state—i.e., not fully rigid, but of course not in a fluid state, which occurs at Tm. Tm and Tg values are widely published for commercial plastic materials. It is understood that each type of plastic may have its own Tg and Tm values.

It is also understood that the process described in FIG. 3 is not the only method to produce the insulated container of the present invention and thus, the method illustrated in FIG. 3 is merely described to exemplify one method of producing the present invention. For example, the container may be produced in a other conventional molding processes and, in another embodiment, may be molded in accordance with the mold similar to that disclosed in U.S. Pat. Nos. 4,783,056 and 4,812,116, respectively. In a further embodiment, the container may be produced in accordance with U.S. Pat. No. 5,723,085. The disclosure of these patents are incorporated by reference herein. The container may be assembled in the mold or may be assembled out of the mold before the material is fully set. In another example, the container may be produced in one or more molding operations and then assembled after the material is fully set. In another embodiment, the ring may be applied after the cups are molded as disclosed in these patents, which are incorporated by reference herein.

In another embodiment, the container may have a lower, small diameter section and an upper, large diameter section with a blending section disposed between the two. In one example, the small diameter section will be of a diameter like that of a conventional hot cup or the like so that the container may be received readily in a cup holder designed for receiving such cups. Through the use of the larger diameter upper section and the small diameter lower section, such cup holders may be appropriately used and yet the capacity of the container made relatively large.

The container assembly of the present invention has superior properties including: high impact resistance both at room temperature and at refrigerated temperature; high insulation properties; and superior dishwasher resistance. The following are a series of tests conducted on the container assembly of the present invention to demonstrate the superior properties of the container assembly.

A) The Fit Between a Lid and a Cup Assembly

This test is conducted on a container having a lid on the cup. For example, for a child “spill-proof” cup, the lid has a spout molded into it. The lid was tested to determine if it twisted on and off the cup “smoothly”—the necessary torque required to apply the lid should be about 25 in-lbs (+/−5). The lid for the container assembly of the present invention was found to twist off “smoothly.”

B) Drop Test

This test is conducted on a container having a lid on the cup. For example, for a child “spill-proof” cup, the lid has a spout molded into it. The container assembly was tested for lid or cup cracking or breaking, or cup/lid separation, after the cup has been filled with 10 ounces of room temperature tap water, the lid applied securely (e.g. for child “spill-proof” cup, a force of 25 in./lbs of torque applied to the lid). The container assembly is dropped ten times from a height of 54 inches. The container assembly should be dropped in the following manner:

2 times directly on spout

2 times directly on edge of lid

2 times directly on side (cup horizontal)

2 times directly on cup bottom

2 times directly on edge or bottom The dual wall cup assembly of the present invention was found to have superior impact strength. For example, when the child spill-proof cup was tested by the above test method, the cup assembly did not break or crack.

The following test method is to be employed for containers other than child “spill-proof” cups. This test method is used to determine the impact strength of products at room temperature (68°-70° F.) and after refrigeration (38°-40° F.).

1) Equipment:

1. Measuring tape with a minimum length of 60 inches

2. Title covered cement floor

3. Product samples and accessory components

4. Water supply

2) Test Method: Room Temperature Impact Strength Testing:

1. On a wall or other surface, measure and mark a height of 54 inches from the tile covered cement floor.

2. Fill the product to recommended capacity with room temperature (68°-70° F.) water.

3. Finish assembly using accessory components normally used with the product being tested.

4. Hold water filled assembled product such that the component being tested is facing the cement floor. The height from the tile covered cement floor to the bottom of the component being tested should be 54 inches.

5. Release the product so the item being tested impacts the tile covered cement floor.

6. Inspect the test component for cracks. If no cracks (failure) have occurred, repeat the drop procedure on the same assembled product 10 times or until failure occurs. Leakage need not be present for a failure to occur.

7. Record the number of drops to failure and the cavity number for the sample.

3) Test Method: For Refrigerated Drop Testing:

This procedure is the same as the room temperature method except for the following:

1. Assembled product needs to be refrigerated a minimum of four hours prior to testing.

2. Drop height is 40 inches instead of 54 inches.

3. Number of drops is 5 instead of 10. The dual wall cup assembly of the present invention has superior impact strength. For example, the cup assembly does not break or crack when subject to the above test methods.

C) Insulation Ability Of The Cup Assembly (Hereinafter Referred to as the “Cup Insulation Test Method”)

1) Equipment:

Digital Thermometer (capable of measuring ° F./° C. with 1° F. accuracy)

Styrofoam Cups

Stopwatch

Environmental Chamber Controlled at 60% RH±4% and 80° F.±2° F.

Refrigerated Chamber (capable of cooling water to 38° F.)

Paper towels or Cardboard (to observe sweating)

Water Cooled to 38° F.±0.5° F.

Ice

Ice cube trays

Volume measuring cup (measures 60 ml±1 ml)

Freezer

2) Test Method

Use ice cube trays to make ice in a freezer. Fill the trays high enough so the ice cubes will weigh 14 grams a piece. Freeze the ice 24 hours prior to running the experiment. Make sure the Ice is in the proximity of the chamber so it will not have an opportunity to melt before it is placed in the cup.

Cool water to 38° F. in a refrigerator or an environmental chamber 24 hours prior to running the experiment.

Set an environmental chamber to 80° F. and 60% RH at least 24 hours for 1 hour prior to running the experiment.

Place a piece of cardboard or paper towels on the tray in the chamber.

Retrieve enough digital thermometers and Styrofoam cups to match the number of samples to be run in the experiment.

In less than 1 minute retrieve the cooled water and the ice cubes. Make sure the ice does not melt or the water have time to warm up before the test is started. Add the ice and water to each cup to be tested as quickly as possible (must be less than 2 minutes) in the ratio of 25 grams of ice for every 3 ounces of water added. For all cups tested add 28 grams of ice (approximately the weight of 2 ice cube) and 3.36 ounces of water to the cup.

Record the test start time and start the stopwatch.

After all the water and ice has been added to the samples, cover the cups with Styrofoam cups. The styrofoam cup should be placed over the cup upside down such that the bottom of the styrofoam cup faces up. Use the thermometer to punch a hole in the bottom of the Styrofoam cups and insert the thermometer into the ice water.

Observe the cups for sweating and record the results. Record the time when the first drop of sweat appears, the time when the first drop of sweat hits the cardboard or towel, the time until an entire wet ring forms on the cardboard or towel.

Record the temperatures in all the cups tested every 10 minutes and record the results.

The test is complete when the temperature of the water in the cup reaches 70° F.

Record all results.

The dual wall cup assembly of the present invention was found to have superior insulation ability. For example, when the child spill-proof cup was tested by the above test (i.e. cup insulation test method), the cup assembly took at least 100 minutes (more specifically over 110 minutes) to reach 70° F. compared to a comparable single wall cup (e.g. a cup having a similar wall thickness as a wall of the dual wall cup, a similar material and a similar size of the dual wall cup). In another example, when the child spill-proof cup was tested by the above test (i.e. cup insulation test method), the cup assembly took at least about twice the time (more specifically about three times) to reach 70° F. compared to a comparable single wall cup (e.g. a cup having a similar wall thickness as a wall of the dual wall cup, a similar material and a similar size of the dual wall cup).

C) Dishwasher Test

This test method is used to evaluate the effect of dishwater cycles on the container assembly.

1) Equipment

A) Dishwater (Kenmore Ultra Wash Dishwasher)

B) Cascade Powder Detergent (Regular Strength)

C) Dishwater Net Bag (for small parts)

2) Test Method

1. Put the container on the shelf in the dishwasher.

2. Fill dishwasher detergent receptacle with Cascade Powder Detergent.

3. Set dishwasher for Natural Cycle and run the dishwasher for the complete cycle duration (wash and dry). At the completion of the cycle, open dishwasher door and allow parts to cool for an additional 10 minutes.

4. Repeat Steps 2 and 3 for X number of cycles.

5. After all cycles are complete, remove all parts and allow them to cool in air at room temperature for a minimum of 1 hour before proceeding with functional testing.

The dual wall cup assembly of the present invention passed this test.

1-31. (canceled)

32. A method of producing a dual wall cup comprising the following steps:
(a) forming both an inner cup and an outer cup both cups made of a thermoplastic material, in at least one mold by an injection molding process;
(b) opening the mold and aligning a mold piece corresponding with the inner cup with a mold piece corresponding with the outer cup;
(c) sufficiently closing the mold so that the cups mate and form a gap between side walls of an inner surface of the outer cup and an outer surface of the inner cup and between bottom walls of the inner and outer cups,
d) forming an overmold ring that is applied to the cup assembly and located at an outer portion of the cup assembly in an area where a top end of the outer cup mates with the inner cup to seal the gap and to form a shrinkage fit with the cup assembly; and
(e) opening the mold and ejecting the cup assembly from the mold to form a dual wall cup assembly comprising: (i) an outer cup having a side wall, a larger top and a smaller end, the end is closed and sealed by bottom wall and the top is open; (ii) an inner cup having a side wall, a larger top and a smaller end, the end is closed and sealed by bottom wall; and (iii) the inner cup is configured to be receivable within the outer cup to create a gap between side wall of an inner surface of the outer cup and an outer surface of the inner cup and between the bottom walls.

33. The method of claim 32 comprising the additional step:
applying a negative pressure to the gap between the inner and outer cup while the cup assembly is in the mold and prior to applying the overmold ring to the cup assembly, the negative pressure is of a sufficient size to pull air, which is between the inner and outer cup, that is sufficiently displaced in the time required to bring the inner and outer cup together.

34. (canceled)

35. The method of claim 32, wherein the overmold ring is formed by injecting a second layer of plastic over the cup assembly.
